(19) United States
(12) Patent Application Publication
(10) Pub. No.: US 2014/0366919 A1
(43) Pub. Date: Dec. 18, 2014

(54) Cleaning Article

(71) Applicants: Marine Cabirol, Ludwigshafen (DE); Lucia Krubasik, Ludwigshafen (DE); Judith Preuschen, Ludwigshafen (DE); Pavlinka Roy, Ludwigshafen (DE); Jordi Salvador, Barcelona (ES)

(72) Inventors: Marine Cabirol, Ludwigshafen (DE); Lucia Krubasik, Ludwigshafen (DE); Judith Preuschen, Ludwigshafen (DE); Pavlinka Roy, Ludwigshafen (DE); Jordi Salvador, Barcelona (ES)

(73) Assignee: RECKITT BENCKISER N.V., Hoofddorp (NE)

(21) Appl. No.: 13/982,736

(22) PCT Filed: Jan. 30, 2012
(86) PCT No.: PCT/GB2012/050186

§ 371 Date: Nov. 4, 2013

(30) Foreign Application Priority Data
Jan. 31, 2011 (GB) 1101536.9

(51) Int. Cl. C11D 17/04

(52) U.S. Cl. CPC C11D 17/04
USPC 134/25.2; 510/224

(57) ABSTRACT

A unit-dose cleaning article comprising cleaning agents in a wrapping, wherein at least 50% by weight of the cleaning agents is constituted by elements which individually are of volume in the range of from 50 to 800 mm³. The article may be used in ware washing, preferably in dishwashing.

This invention relates to a cleaning article, in particular to a unit-dose cleaning article for use in ware-washing, for example in laundry washing machines, or dishwashing machines.

Unit-dose cleaning articles have proved popular with consumers. They offer benefits of ease of use, cleanliness of handling and consistency of dosing.

Cleaning articles may be “pouches” in which the washing agents are retained within a water-soluble polymer wrapping. Such pouches often include as major constituents particulates wrapped in a water-soluble polymer wrapping; or liquid or gel wrapped in a water-soluble polymer wrapping; or a combination of particulates, and liquid or gel, in one compartment or housed in separate compartments, all wrapped in a water-soluble polymer wrapping. Articles may also include compressed tablets of particulate materials, wrapped in a water-soluble polymer wrapping.

Cleaning articles may be “bags” in which the washing agents—in a suitable form such as a tablet—are retained within a mesh or web wrapping.

Cleaning articles in the form of tablets wrapped in a water-soluble polymer wrapping or in a mesh or web generally offer little in the way of aesthetic appeal.

Pouches containing particulates (that is, unconsolidated particulates), liquids and gels have the disadvantage of ready escape of the cleaning agents from the article, should the polymer wrapping be breached.

U.S. Pat. No. 6,133,214 describes a portioned detergent composition in a bag of water-soluble film in which at least 70% by weight of the particles of the detergent composition have particle sizes above 800 μm. Preferably the particle size is above 900 μm, more preferably about 1,000 μm and most preferably about above 1,200 μm. It is further stated that in an important embodiment the particle size range is from 0.8 to 5.0 mm, more particularly from about 1.0 to 3.0 mm. In the single example of the invention 93.2% of particles had a particle size greater than 0.8 mm, and 2.5% of particles had a particle size greater than 16 mm.

U.S. Pat. No. 7,074,748 describes a liquid composition comprising a transparent or translucent liquid medium and solid particles having a mean geometric diameter between 5 mm and 12 mm, contained within the liquid medium.

It is an objective of embodiments of the present invention to offer cleaning articles which have functional benefits, whether in manufacturing, packing, storage or at the point of use (or any combination of these).

Alternatively or additionally, it is an objective of embodiments of the present invention to offer the possibility of achieving aesthetic benefits.

In accordance with a first aspect of the present invention there is provided a unit-dose cleaning article comprising cleaning agents in a wrapping, wherein at least 50% by weight of the cleaning agents is constituted by elements which individually are of volume in the range of from 50 to 800 mm³.

Such elements—which may also be called pellets herein—may together constitute at least 60% by weight of the cleaning agents in the article, preferably at least 70%, preferably at least 80%, and more preferably at least 90%. Such elements could constitute 100% of the weight of the cleaning agents in the article in certain embodiments, but this is not preferred. It is preferred that the article contains cleaning agents in a second form, not conforming to the above definition, as will be further described. Preferably, therefore, such elements do not constitute more than 80% by weight of the cleaning agents in the article, preferably not more than 90%, and more preferably not more than 95%.

Preferably the elements to which the above definitions apply are individually of volume at least 60 mm³, preferably at least 80 mm³, more preferably at least 100 mm³, preferably at least 130 mm³, preferably at least 160 mm³.

Preferably the elements to which the above definitions apply are individually of volume up to 700 mm³, preferably up to 600 mm³, preferably up to 500 mm³, preferably up to 400 mm³, more preferably up to 300 mm³.

The elements may be of various shapes (which is one reason why the invention is defined with reference to volume (and by weight hereafter), rather than by a linear metric such as mean particle size or mean diameter. Exemplary shapes for the elements include spherical, substantially ovoid, and substantially cylindrical (including circularly cylindrical, elliptically cylindrical and prismatically cylindrical) elements.

The elements may be made by moulding or compression, or by extrusion of cleaning agents into strands, and then chopping. When the elements are cylindrical, the strands are chopped, to produce the elements directly. When the elements are not cylindrical the strands may be chopped and the final shape may be formed by rolling or rounding.

The elements may be tablets produced by any conventional tablet forming method, for example powder compaction.

Preferably the elements are pellets composed of admixed materials useful in cleaning. However more complex elements are not excluded from the scope of the invention. Examples could include elements of shell/core structure which have, for example, a liquid core encapsulated by a water-soluble shell.

The elements could all be identical, or there could be more than one type of element; with each type conforming to at least one of the definitions given above.

Preferably there are two types of element. These may be of different sizes (but need not be). These could be of different shapes (but need not be). They could be of different colours (but need not be). They could be of different compositions (but need not be); for example they could contain respective components which are desirably kept apart; for example enzymes, and bleach agents or bleach precursors. There may be only two types of element; or there may be more than two types.

It was mentioned above that there may be cleaning agents contained within the cleaning article, additional to the said elements. One such example is cleaning agents in the form of interstitial sub-elements which are of smaller volume than the defined elements, and which can occupy the interstices between the elements, so as to improve the packing density. Interstitial sub-elements may include granulates and microcapsules (preferably being core-shell microcapsules comprising a water-soluble skin and a liquid core.

Preferably the interstitial sub-elements together constitute less than 50% of the weight of the cleaning agents in the article; preferably not more than 40%, preferably not more than 30%, preferably not more than 20%.

Preferably the mean volume of the interstitial sub-elements (individually) is less than 50 mm³, preferably less than 35 mm³, preferably less than 20 mm³, more preferably less than 10 mm³. Preferably the mean volume of the interstitial sub-elements is at least 0.2 mm³, preferably at least 1 mm³, preferably at least 3 mm³.

Preferably such interstitial sub-elements have a strong colour.

Preferably the interstitial sub-elements are of a contrasting colour to the defined elements. For example if the elements are white, or pale blue, or a mixture of white and pale blue, interstitial sub-elements may desirably be one or more bright hue(s) of red, orange, green, purple etc.

A further example of cleaning agents contained within the cleaning article, additional to the said elements, is a gel or liquid. However the situation is not one in which the elements are within a major amount of the liquid or gel: it has already been stated that at least 50% by weight of the cleaning agents is constituted by the said elements.

Preferably the elements are not suspended in, and do not float on, and do not sink from, the liquid or gel, when present. Being present in a substantial proportion, the situation is that the elements are wetted by the liquid or gel. Preferably the situation is one in which the liquid or gel, when present, is like a liquid or gel coating or lubricant for the elements.

Preferably the liquid or gel constitutes less than 50% by weight of the cleaning agents in the article, preferably not more than 40%, preferably not more than 30%, preferably not more than 20%.

Another example of cleaning agents additional to the said elements is an inclusion which is of volume in excess of 800 mm³, preferably in excess of 1200 mm³. Preferably such an inclusion is of volume up to 6000 mm³, preferably up to 4500 mm³. Such an inclusion may be a block or ball, for example nesting within the elements. The inclusion may be solid, and formed by a compression or moulding, or it may be formed by extrusion followed by chopping, followed by rolling or rounding; or it may be of core/shell construction, the core being a solid, a liquid or a gel.

Such an inclusion, or such inclusions in total when there is more than one, each as defined in the preceding paragraph, constitute(s) less than 50% by weight of the cleaning agents in the article, preferably not more than 40%, preferably not more than 30%, preferably not more than 20%.

In one embodiment the cleaning agents in the article are provided only by said elements.

In another embodiment the cleaning agents in the article are provided only by said elements and said interstitial sub-elements.

In another embodiment such cleaning agents in the article are provided only by said elements and said gel or liquid.

In another embodiment such cleaning agents in the article are provided only by said elements and one more of said inclusions.

In another embodiment such cleaning agents in the article are provided only by said elements, said interstitial sub-elements and said liquid or gel.

In another embodiment such cleaning agents in the article are provided only by said elements, said interstitial sub-elements and one or more said inclusions.

In another embodiment such cleaning agents in the article are provided only by said elements, said gel or liquid and one or more of said inclusions.

In another embodiment such cleaning agents in the article are provided only by said elements, said interstitial sub-elements, said liquid or gel, and one or more said inclusions.

The wrapping may be closed tightly around the cleaning agents (with evacuation of the air content, if wished) to produce a tight, hard cleaning article. Preferably, however, no vacuum technique is used, and, indeed, the wrapping is preferably not drawn tightly around the cleaning agents. Preferably the cleaning agents are loose in the article. Preferably the cleaning agents have the freedom to move within the cleaning article. Preferably the article may change it shape. Preferably it is conformable to the shape of a receptacle into which it is to be located, for example the dosing chamber of a dishwashing machine.

The cleaning article may be pillow-shaped or cushion-shaped. It may, in preferred embodiments, be a pyramidal (for example tetrahedral of trigonal) sac in which the edges are of the wrapping are drawn upwards and together, and sealed (for example by means of adhesive, or heat-sealing) to form sac (preferably such that it resembles a filled won-ton or drawstring purse in its overall appearance). It may suitably be sealed along one or more seams or at a gathered-together top region.

Preferably the cleaning article has one compartment only, in which the cleaning agents, comprising the said elements, are present.

In certain preferred embodiments the wrapping is a water-soluble sheet material. Such embodiments may be called pouches, following conventional terminology.

As is conventional, it is intended in such embodiments that the wrapping must be dissolved, in use, for the cleaning agents to be released. A water-soluble wrapping suitably has no perforations, other than a small venting hole to allow escape of gases generated within the article (e.g. O₂ produced by decomposition of bleach compounds).

A water-soluble polymeric material for use in such embodiments may suitably be selected from the group comprising polyvinyl alcohols, polyvinyl alcohol copolymers, partially hydrolyzed polyvinyl acetates, cellulose derivatives (such as alkylcelluloses, hydroxyalkylcelluloses, salts, ethers and esters of alkylcelluloses and hydroxyalkylcelluloses, for example, hydroxypropylcellulose, hydroxypropylmethyl-cellulose and sodium carboxymethylcellulose); polyglycolides, polyglycolic acids, polylactides, polylactic acids; polyvinyl pyrrolidines, polyacrylic acids or salts or esters thereof, polymaleic acids or salts or esters thereof, dextrins, maltodextrins, polyacrylamides, acrylic acid/maleic anhydride copolymers, including copolymers (which includes terpolymers), and blends. Optionally fillers, plasticisers and process aids may also be comprised in the formulation of a water-soluble polymeric material for use herein.

Preferred polymeric materials are selected from the group comprising polyvinyl alcohols, polyvinyl alcohol copolymers, and partially hydrolyzed polyvinyl acetates. An especially preferred water-soluble polymeric material comprises a poly(vinyl alcohol).

In certain preferred embodiments the wrapping is a sheet material in the form of a mesh or web. Such embodiments are called bags. The size of the openings in the mesh or web is suitably of such as a size that the elements, and interstitial sub-elements if such are present, are retained in the article, prior to use.

The mesh or web may be of a water-soluble polymer or may be of a polymer which does not dissolve in the ware-washing machine. In the latter case the user may discard the bag when emptying the dishwashing machine. However provision for the user to refill the bag for a subsequent wash is not excluded.

The use of the defined elements, especially in certain embodiments with one or more of interstitial sub-elements, liquid or gel, and one or more inclusions, allows for different aesthetic possibilities, and offers technical benefits. Furthermore embodiments which have been defined, and which are described hereinafter, offers benefits to manufacturer and consumer alike. For example preferred embodiments in which the cleaning agents, comprising the elements, are free to move within a article, which is shape-adjustable, to give packaging benefits to manufacturers, because space-filling is efficient, and benefit in fitting the cleaning article into the loading drawer of any warewashing machine, in conforming to different drawer shapes; as well as an interesting appearance and tacticity. The possibility of contrasting elements, and of the presence of one or more of the intersticial sub-elements, liquid or gel, and inclusion(s), allows for the separation of chemical components which are desirably kept apart, and for a high degree of control over the rate of dissolution of different components within the cleaning agent.

The article may be of benefit in the context of dishwashing or laundry washing.

Suitable components of dishwashing cleaning agents used in the present invention are as follows.

### Builders

The cleaning agents may comprise conventional amounts of detergent builders which may be either phosphorus based (e.g. STPP) or non-phosphorus based, or even a combination of both types. Suitable builders are well known in the art. Non-phosphorus builders are preferred.

Non-phosphorus based builder may be organic molecules with carboxylic group(s), amino acid based compound or a succinic acid or succinate based compound.

Builder compounds which are organic molecules containing carboxylic groups include citric acid, fumaric acid, tartaric acid, maleic acid, lactic acid and salts thereof. In particular the alkali or alkaline earth metal salts of these organic compounds may be used, and especially the sodium salts. An especially preferred builder is sodium citrate.

Preferred examples of amino acid based compounds according to the invention are MGDA (methyl-glycine-diacetic acid, and salts and derivatives thereof) and GLDA (glutamic-N,N-diacetic acid and salts and derivatives thereof). GLDA (salts and derivatives thereof) is especially preferred according to the invention, with the tetrasodium salt thereof being especially preferred.

Preferably the total amount of builder present in the cleaning agents of the invention is an amount of at least 5% wt, preferably at least 20% wt, more preferably at least 30% wt, and most preferably at least 40% wt.

Preferably the total amount of builder present in the cleaning agents of the invention is an amount of up to 80% wt, preferably up to 70% wt, preferably up to 60% wt, and most preferably up to 50% wt.

### Surfactants

The cleaning agents of the invention may contain surfactants. Preferred surfactants are anionic surfactants and non-ionic surfactants. Many such surfactants are described in Kirk Othmer's Encyclopedia of Chemical Technology, 3rd Ed., Vol. 22, pp. 360-379, “Surfactants and Detersive Systems”.

A preferred class of nonionic surfactants is alkoxylated non-ionic surfactants prepared by the reaction of a monohydroxy alkanol or alkylphenol having 6 to 20 carbon atoms, preferably 10 to 18 carbon atoms, most preferably 12 to 15 carbon atoms. Preferably the surfactants have at least 10 moles of ethylene oxide and/or propylene oxide, preferably at least 12 moles, per mole of alcohol or alkylphenol; most preferably 5-10 moles of ethylene oxide and 3-6 moles of propylene oxide, per mole of alcohol or alkylphenol.

Preferably the surfactant(s) is/are present in the cleaning agents used in the invention in an amount of from 0.1% wt, more preferably from 0.2% wt, most preferably from 0.5% wt.

Preferably the surfactant(s) is/are present in the cleaning agents used in the invention in an amount of up to 10% wt, preferably up to 5% wt, most preferably up to 3% wt.

### Anti-Corrosion Agents

It is known to include a source of multivalent ions in cleaning agents, and in particular in automatic dishwashing compositions, for technical and/or performance reasons. For example, multivalent ions and especially zinc and/or manganese ions have been included for their ability to inhibit corrosion on metal and/or glass. Zinc sulphate is a preferred compound for this purpose.

Any conventional amount of multivalent ions/multivalent ions source may be included in the cleaning agents used in the invention. However, it is preferred that the multivalent ions are present in an amount of from 0.01% wt, preferably of from 0.05% wt, preferably of from 0.1% wt. It is preferred that the multivalent ions are present in an amount of up to 5% wt, preferably up to 3% wt, preferably up to 2.5% wt.

### Performance Polymers

Polymers intended to improve the cleaning performance of the cleaning agents may also be included therein. For example sulphonated polymers may be used. Preferred examples include copolymers of CH₂═CR¹—CR²R³—O—C₄H₃R⁴—SO₃X wherein R¹, R², R³, R⁴ are independently 1 to 6 carbon alkyl or hydrogen, and X is hydrogen or alkali with any suitable other monomer units including modified acrylic, fumaric, maleic, itaconic, aconitic, mesaconic, citraconic and methylenemalonic acid or their salts, maleic anhydride, acrylamide, alkylene, vinylmethyl ether, styrene and any mixtures thereof. Other suitable sulfonated monomers for incorporation in sulfonated (co)polymers are 2-acrylamido-2-methyl-1-propanesulfonic acid, 2-methacrylamido-2-methyl-1-propanesulfonic acid, 3-methacrylamido-2-hydroxypropane-sulfonic acid, allysulfonic acid, methallysulfonic acid, 2-hydroxy-3-(2-propenyl-oxy)propanesulfonic acid, 2-methyl-2-propenen-1-sulfonic acid, styrenesulfonic acid, vinylsulfonic acid, 3-sulfopropyl acrylate, 3-sulfopropylmethacrylate, sulfomethylacrylamide, sulfomethylmethacrylamide and water soluble salts thereof.

When a sulfonated polymer is present, it is preferably present in the cleaning agents in an amount of at least 0.1% wt, more preferably at least 1% wt, preferably at least 2% wt, and most preferably at least 5% wt. A sulfonated polymer, when present, is preferably present in the cleaning agents in an amount of up to 30% wt, preferably up to 20% wt, most preferably up to 15% wt.

### Enzymes

The cleaning agents of the invention may comprise one or more enzymes. It is preferred that the enzyme is selected from protease, lipase, amylase, cellulase and peroxidase enzymes.

Desirably enzyme(s) is/are present in the cleaning agents in an amount of from 0.01% wt, especially of from 0.1% wt, most preferably of from 0.2% wt. Desirably enzyme(s) is/are present in the cleaning agent in an amount of up to 10% wt, preferably up to 7% wt, most preferably up to 5% wt.

### Bleaching Compounds

Any type of bleaching compound conventionally used in dishwashing compositions may be used according to the present invention. Preferably the bleaching compound is selected from inorganic peroxides or organic peracids, derivatives thereof (including their salts) and mixtures thereof. Especially preferred inorganic peroxides are percarbonates, perborates and persulphates with their sodium and potassium salts being most preferred. Sodium percarbonate and sodium perborate are most preferred, especially sodium percarbonate.

Organic peracids include all organic peracids traditionally used as bleaches, including, for example, perbenzoic acid and peroxycarboxylic acids such as mono- or diperoxyphthalic acid, 2-octyldiperoxysuccinic acid, diperoxydodecanedicarboxylic acid, diperoxy-azelaic acid and imidoperoxycarboxylic acid and, optionally, the salts thereof. Especially preferred is phthalimidoperhexanoic acid (PAP).

Bleaching compounds herein may include bleach activators and bleach catalysts.

When a bleaching compound is present in the cleaning agents of the invention it is suitably present in an amount of from 1% wt, preferably of from 2% wt, most preferably of from 5% wt; and preferably an amount up to 40% wt, preferably up to 30% wt, most preferably up to 20% wt.

A bleaching compound may be protected from another component which it may degrade, and/or which may cause its own degradation. For examples a bleaching compound and an enzyme may be protected from each other, by physical separation.

### Other Components

The cleaning agents of the invention may also comprise minor, conventional amounts of thickeners, wetting agents, perfumes, preservatives and/or colourants. Such ingredients are typically present in amounts of up to 2% wt.

The cleaning agent may suitably comprise water. Suitably the water content is not more than 30% wt, preferably not more than 20% wt, preferably not more than 10% wt, preferably not more than 5% wt, of the cleaning agents.

All of the numerical definitions given above for amounts of a component of the cleaning agents represent the total amount of such components, when more than one is present e.g. the total enzyme content, when there are two types of enzyme, or two or more types of bleach compounds.

% wt values given herein mean percentage by weight of the specified component, as a percentage of the total weight of the cleaning agent.

The invention may also be expressed in terms of the weight characteristics of individual elements.

In accordance with a second aspect of the present invention there is provided a unit-dose cleaning article comprising cleaning agents in a wrapping, wherein at least 50% by weight of the cleaning agents is constituted by elements which individually are of weight in the range of from 65 mg to 1.4 g.

Such elements of the second aspect may constitute at least 60% by weight of the cleaning agents in the article, preferably at least 70%, preferably at least 80%, and more preferably at least 90%. Such elements of the second aspect could constitute 100% of the cleaning agents in the article in certain embodiments, but this is not preferred. It is preferred that the article contains cleaning agents in a second form, as will be further described. Preferably, therefore, such elements of the second aspect do not constitute more than 80% by weight of the cleaning agents in the article, preferably not more than 90%, and more preferably not more than 95%.

Preferably the said elements of the second aspect are individually of weight at least 80 mg, preferably at least 100 mg, more preferably at least 130 mg, preferably at least 200 mg, more preferably at least 250 mg.

Preferably the said elements of the second aspect are individually of weight up to 1.2 g, preferably up to 1.0 g, preferably up to 0.85 g, preferably up to 0.7 g, more preferably up to 0.5 g.

The definitions given above in relation to the first aspect apply to the second aspect, but the following further definitions also apply in relation to the second aspect.

Preferably the mean weight (individually) of the interstitial sub-elements, when present, is less than 65 mg, preferably less than 50 mg, preferably less than 32 mg, more preferably less than 16 mg. Preferably the mean weight of the interstitial sub-elements is at least 0.3 mg, preferably at least 1.5 mg, preferably at least 4 mg.

Preferably said inclusion, when provided (or each inclusion when more than one is present), is of weight in excess of 1.4 g, preferably in excess of 2 g. Preferably the or each said inclusion is of weight up 10 g, preferably up to 8 g.

In accordance with a third aspect of the present invention there is provided a method of ware washing, and preferably a method of washing articles in a dishwashing machine, using a unit-dose cleaning article as defined in the first or second aspect herein.

The invention will now be further described by way of example, with reference to the accompanying drawings, in which:

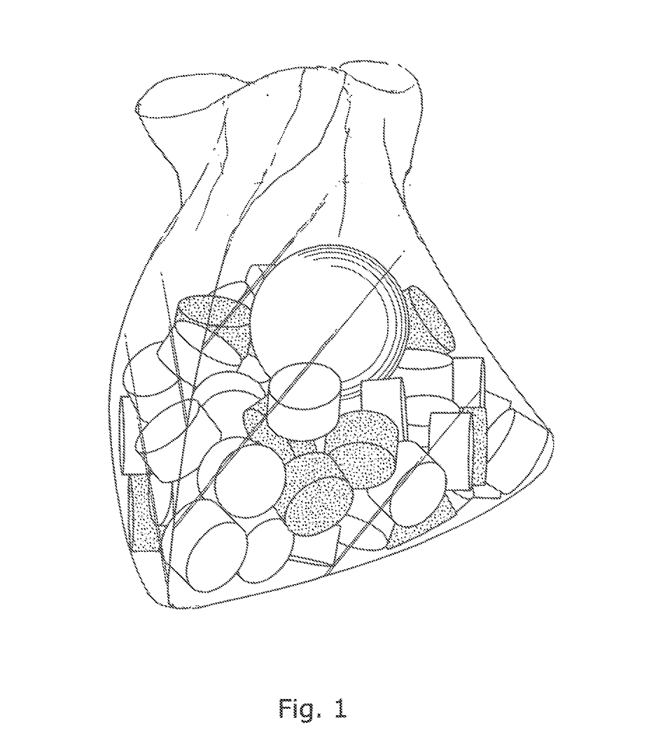

FIG. 1 shows a first embodiment of the invention in perspective view;

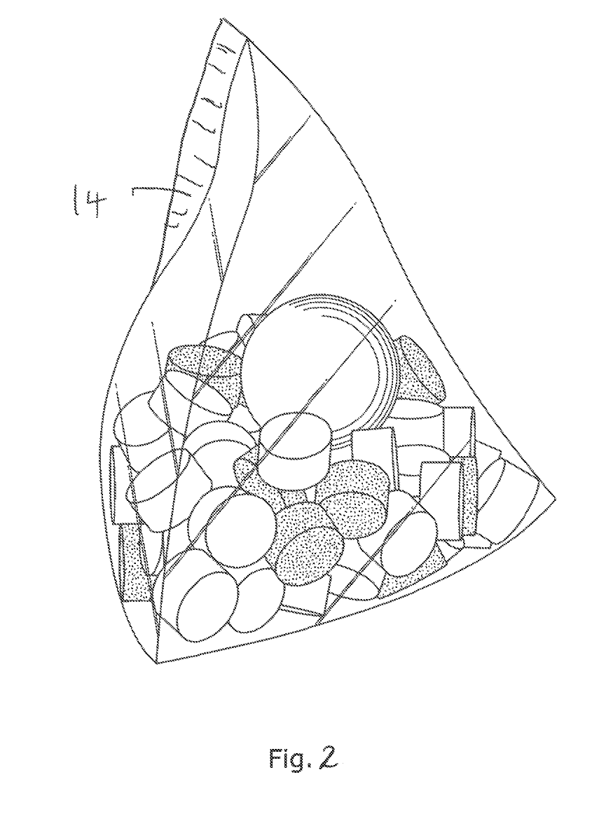

FIG. 2 shows a further embodiment of the invention in perspective view;

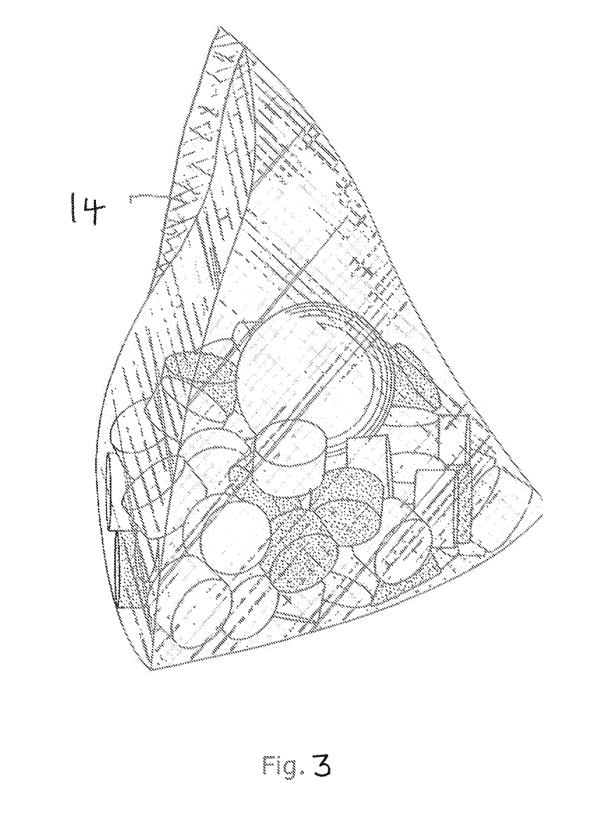

FIG. 3 shows a further embodiment of the invention in perspective view;

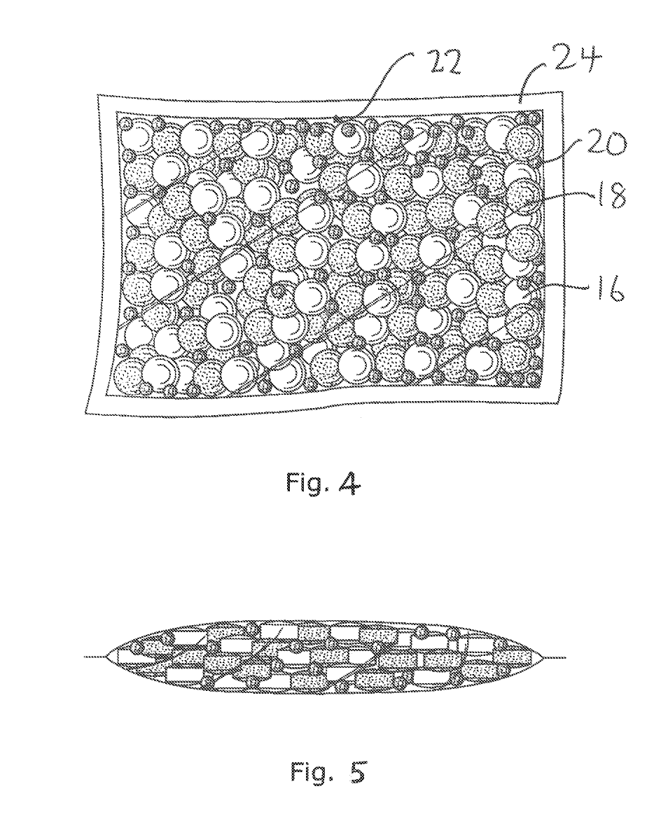

FIG. 4 shows a further embodiment of the invention in plan view; and

FIG. 5 shows the embodiment of FIG. 4 in end elevation.

FIG. 1 shows a generally-pyramidal or tetrahedral cleaning article in the form of a pouch 2. The wrapping 4 of the article is transparent, water-soluble polyvinyl alcohol. Inside the pouch are cleaning agents suitable for use in a ware washing machine. The chemical composition of the cleaning agent is not especially relevant to the invention but includes materials typically employed for this purpose, such as those described above, for example: non-ionic surfactant, enzymes, bleaching agents, corrosion protection agent, glass protection agent and drying aid.

The cleaning agents are present in a multiplicity of (several dozen in this embodiment) elements or pellets, and a single, larger spherical inclusion. The elements or pellets make up the major proportion of the cleaning agents.

The elements provided are white elements 6, and coloured elements 8. These are of similar composition to each other, except that the white elements contain enzymes and no bleach components, and the coloured elements contain bleach components and no enzymes. The elements are made by extruding strands of dishwashing compositions, and chopping the strands into required lengths. Each pellet, whether white or coloured, is a circular cylinder approximately 6 mm in diameter, and approximately 6 mm in length (volume of approximately 170 mm³) and weight approximately (0.25 g).

The inclusion 10 is of shell/core construction. The shell is of water-soluble polyvinyl alcohol. The core is a liquid agent which assists drying of cutlery, crockery and glassware in a dishwashing machine, without leaving drying residues. The inclusion is a spherical ball of approximately 1.5 cm in diameter, and weight approximately 6 g.

The wrapping is loose around the elements and the inclusion. The wrapping is drawn up into a neck 12, which is heat-sealed (such that the cleaning article is like a filled won-ton, or a drawstring purse, and is a truncated tetrahedron, in overall shape). No vacuum is applied during the closure process. The elements and the inclusion inside the pouch may be manipulated by hand; the elements and inclusion are quite movable, within the article. The tactile sensation provided is quite different to that provided by a tablet in which the wrapping is applied using vacuum and heat. The pouches may be packed into boxes very efficiently; they may readily conform to the spaces available. Furthermore, when they are used in a dishwashing machine they may readily adapt themselves to the shape of any loading drawer of the machine.

The second embodiment shown in FIG. 2 is the same as the first embodiment, expect that that closure is achieved by a face to face heat seal 14 along an edge of the article, which is also a little more “tetrahedral” (non-truncated) in shape.

In related embodiments to those of FIGS. 1 and 2 no inclusion is present; only the elements or “pellets”.

The embodiment shown in FIG. 3 differs from the second embodiment, in that the wrapping is a mesh or web. The mesh or web may be of polymeric material which does not dissolve in the dishwashing cycle.

In a related embodiment the cleaning article looks that same as the FIG. 3 article but the mesh is water-soluble.

In the embodiment shown in FIGS. 4 and 5, elements 16, 18, white and blue in colour, of the same size and shape as those used in FIGS. 1 and 2, are employed. However there is no large inclusion. There are, however a large number of approximately spherical microcapsules (interstitial sub-elements) 20, each of diameter approximately 2 mm and weight approximately 6 mg. These are of core/shell structure. The wrapping is of water-soluble polyvinyl alcohol. The core is a liquid agent which assists drying of cutlery, crockery and glassware in a dishwashing machine, without leaving drying residues. The microcapsules constitute approximately 14 wt % of the total cleaning agents in the pouch. Also present is a relatively small quantity of gel; approximately 12 wt % of the total cleaning agents in the pouch. At this level the gel does not provide a matrix to suspect the elements and microcapsules. Rather, it acts to “lubricate” them, to improve their handling.

As can be seen in FIGS. 4 and 5 the cleaning article of this embodiment is generally in the shape of a pillow, having a single enclosed region 22 in which the cleaning agents are present, and a frill 24 extending all the way around it, in a medial plane. The frill represents the regions in which two polyvinyl alcohol sheets have been brought together, and heat-sealed (without use of a vacuum) to enclose the cleaning agents, in the enclosed central region. The microcapsules have a colour which is striking, against the background of the white and blue elements. The example the microcapsules may be bright red. The gel may also be coloured if wished.

This embodiment is visually striking and, moreover, is efficient in terms of utilisation of space. The microcapsules readily locate within the interstices between the elements. Aided by the lubricating action of the gel and the lack of vacuum, the article is pleasant to handle and flexible, such that it can conform to the shape of any dishwashing dosing chamber.

1. A unit-dose cleaning article comprising:
a wrapping; and
cleaning agents in the wrapping;
wherein at least 50% by weight of the cleaning agents is constituted by elements which individually are of volume in the range of from 50 to 800 mm³.

2. The article as claimed in claim 1, wherein at least 50% by weight of the cleaning agents is constituted by elements which individually are of volume in the range of from 100 to 400 mm³.

3. The article as claimed in claim 1, wherein there are two types of elements which differ from each other in one or more of the following characteristics: size; shape; colour; and composition.

4. (canceled)

5. The article as claimed in claim 1 further comprising interstitial sub-elements which are of smaller volume than the cleaning elements;
wherein the mean volume of the interstitial sub-elements (individually) is in the range of from 0.2 mm³ to 50 mm³.

6. The article as claimed in claim 1 further comprising a gel or liquid.

7. The article as claimed in claim 1 further comprising an inclusion which is of volume in excess of 800 mm³.

8. The article as claimed in claim 1, wherein the cleaning agents are loose in the article.

9. The article as claimed in claim 8, wherein the cleaning article has a shape selected from the group consisting of pillow-shaped, cushion-shaped, and pyramidal.

10. The article as claimed in claim 1, wherein the wrapping is a sheet material in the form of a mesh or web.

11. The article as claimed in claim 1, wherein the wrapping is a water-soluble sheet material.

12. A unit-dose cleaning article comprising:
a wrapping; and
cleaning agents in the wrapping;
wherein at least 50% by weight of the cleaning agents is constituted by elements which individually are of weight in the range of from 65 mg to 1.4 g.

13. The article as claimed in claim 12 further comprising one or more of:
interstitial sub-elements, of weight at least 0.3 mg but less than 65 mg;
an inclusion, of weight in excess of 1.4 g, and up to 10 g; and
a gel or liquid.

14. A method of ware washing, using a unit-dose cleaning article as claimed in claim 1.

15. The method as claimed in claim 14, being a method of washing articles in a dishwashing machine.

16. A unit-dose cleaning article comprising:
a wrapping; and
cleaning agents in the wrapping;
wherein at least 50% by weight of the cleaning agents is constituted by elements that individually are of volume in the range of from 50 to 800 mm³; and
wherein at least 50% by weight of the cleaning agents is constituted by elements which individually are of weight in the range of from 65 mg to 1.4 g.

17. The article as claimed in claim 16 further comprising interstitial sub-elements that are of smaller volume than the cleaning elements;
wherein the mean volume of the interstitial sub-elements (individually) is in the range of from 3 mm³ to 35 mm³;
wherein at least 50% by weight of the cleaning agents is constituted by elements that individually are of volume in the range of from 100 to 400 mm³; and
wherein there are two types of cleaning agents that differ from each other in one or more of the following characteristics: size; shape; colour; and composition.

18. The article as claimed in claim 16 further comprising a gel or liquid;
wherein at least 50% by weight of the cleaning agents is constituted by elements that individually are of volume in the range of from 100 to 400 mm³; and
wherein there are two types of cleaning agents that differ from each other in one or more of the following characteristics: size; shape; colour; and composition.

19. The article as claimed in claim 16 further comprising an inclusion that is of volume in the range from 1200 mm³ up to 4500 mm³;
wherein at least 50% by weight of the cleaning agents is constituted by elements that individually are of volume in the range of from 100 to 400 mm³; and
wherein there are two types of cleaning agents that differ from each other in one or more of the following characteristics: size; shape; colour; and composition.
